(19) United States
(12) Patent Application Publication
(10) Pub. No.: US 2006/0020940 A1
(43) Pub. Date: Jan. 26, 2006

(54) Soft-partitioning systems and methods

(76) Inventor: Bradley Gordon Culter, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/085,757

(22) Filed: Mar. 21, 2005

Related U.S. Application Data
(60) Provisional application No. 60/586,201, filed on Jul. 8, 2004.

(51) Int. Cl. G06F 9/46

(52) U.S. Cl. 718/100

(57) ABSTRACT

Embodiments of soft-partitioning systems and methods are disclosed. One system embodiment, among others, includes a first operating system (O.S.) instance and a second O.S. instance, a hardware component, a shared hardware proxy, and a shared hardware protocol interface configured with the shared hardware proxy to enable sharing of the hardware component between the first O.S. instance and the second O.S. instance.

### CROSS-REFERENCE TO RELATED APPLICATION

This application claims the benefit of U.S. Provisional Application No. 60/586,201, filed Jul. 8, 2004, which is entirely incorporated herein by reference.

### BACKGROUND

Prior computer platforms have included symmetric multi-processor (SMP) arrangements where multiple central processing units (CPUs) execute a single copy of an operating system (OS). The OS provides time sharing services to allow multiple applications to run. However, this arrangement permits the applications to interfere with each other, which leaves the system vulnerable to failures. For example, any problem with one application could corrupt the resources for other applications.

A known solution to this problem is to separate the computer system into partitions or protected domains. Depending on the type of partitioning implemented, a computer system's resources may be effectively placed into separate functional blocks wherein resources in one block do not have direct access to resources in another block. Certain types of partitioning may completely isolate resources in each partition such that an application operating in one partition has no access to resources in another partition. Other types of partitioning may be less restrictive such that certain resources may be shared across a plurality of different partitions. In general, partitioning computer resources may effectively prevent one application from using the entire system resources, as well as contain faults and errors that may arise within a partition. Partitions thus allow multiple OSs and applications to coexist on a single box (or set of computer resources) and be reliably protected from each other's failures and, for the most part, protected from each other's use of system resources.

Partitioning techniques range from those deeply rooted in the system's hardware to others that are entirely software-based. Soft-partitioning is one type of partitioning. Sometimes referred to as logical partitioning, it enables multiple instances of an OS to run simultaneously on one computer by dividing the computer into soft partitions. In soft partitioning, software is used to configure and supervise various partitions. Thus, rather than partitioning resources through physical partitioning (e.g., in which the hardware enforces the partitions, such as hard partitioning techniques), a software supervisory layer may be implemented to define partitions and assign the system's resources that are to be reserved for each partition as well as any resources that are to be shared between the partitions. Through the software configuration, each soft partition may be assigned its own subset of hardware, runs a separate instance of the OS, and hosts its own set of applications.

One problem that may occur in soft partitioning is that there may not be enough hardware resources to dedicate to each soft partition. That is, each soft partition assumes an OS instance, a firmware instance, and hardware (e.g., CPU, registers, interrupt controller, etc.) dedicated to its own operating system and firmware instance. Thus, the amount of soft partitions is limited by the availability of each of these components.

### SUMMARY

An embodiment of a soft partitioning method, among others, comprises instantiating a first operating system (O.S.) instance and a second O.S. instance in a first soft partition and a second soft partition, respectively, and sharing hardware resources between the first O.S. instance and the second O.S. instance.

An embodiment of a soft-partitioning system, among others, comprises a first operating system (O.S.) instance and a second O.S. instance, a hardware component, a shared hardware proxy, and a shared hardware protocol interface configured with the shared hardware proxy to enable sharing of the hardware component between the first O.S. instance and the second O.S. instance.

An embodiment of a soft-partitioning system, among others, comprises means for transferring hardware resource programming from a first operating system (O.S.) instance to a shared hardware protocol, and means for providing sharing of the hardware resources between the first O.S. instance and a second O.S. instance.

An embodiment of a soft-partitioning system, among others, on a computer-readable medium comprises logic configured to adapt hardware resource programming in a first operating system (O.S.) instance to a shared hardware protocol, and logic configured to provide sharing of the hardware resources between the first O.S. instance and a second O.S. instance.

### BRIEF DESCRIPTION OF THE DRAWINGS

The components in the drawings are not necessarily to scale, emphasis instead being placed upon clearly illustrating the principles of the disclosed systems and methods. Moreover, in the drawings, like reference numerals designate corresponding parts throughout the several views.

FIG. 1 is a Unified Modeling Language (UML) diagram that illustrates an embodiment of a soft-partitioning system that includes two exemplary soft-partitions.

FIG. 2 is a UML diagram that illustrates one soft-partition embodiment in the soft-partitioning system shown in FIG. 1.

FIG. 3A is programming diagram of an exemplary header file that defines an embodiment of a shared hardware protocol interface.

FIG. 3B is a flow diagram that illustrates an initialization of the shared hardware protocol interface of FIG. 3A.

FIG. 4 is a UML diagram that shows a soft partition embodiment of FIG. 2, which illustrates interrupt controller hardware initialization.

FIG. 5 is a UML diagram that shows a soft partition embodiment of FIG. 2, which illustrates general purpose event (GPE) register hardware initialization.

FIG. 6 is a UML diagram that shows a soft partition embodiment of FIG. 2, which illustrates interrupt processing.

FIG. 7 is a UML diagram that shows a soft partition embodiment of FIG. 2, which illustrates GPE register access.

### DETAILED DESCRIPTION

Disclosed herein are various embodiments of soft partitioning systems and methods (herein referred to as a soft partitioning system for brevity). In particular, a soft partitioning system is disclosed that uses a shared hardware (SHWA) protocol interface and a corresponding kernel level proxy (SHWA proxy) to enable the sharing of hardware resources. In one embodiment, a SHWA protocol may be part of the firmware, and the SHWA proxy may be part of each OS that supports the SHWA protocol. In some embodiments, a SHWA protocol interface may be provided by a software developer whom also writes a SHWA proxy (i.e., the SHWA proxy and the SHWA protocol are software that may be released by the operating system vendor). By using a firmware interface that manages the sharing between a plurality of operating systems (OSs) that may or may not be different to one or more hardware resources, direct programming by each OS to the particular hardware resource is obviated, avoiding conflicts in hardware usage and dueling policies of the plurality of OSs while preserving the essential functionality of the hardware.

The below description will describe a soft partitioning system in the context of firmware interfaces compatible with the INTEL Processor Family (IPF) processors. In particular, the firmware described herein uses industry standard (IPF) extension mechanisms that OS architectures from various manufacturers can use with little modification. Thus, in one embodiment, a soft partitioning system includes a plurality of soft partitions that each run an instance of an OS. An instance generally refers to a copy of software or firmware code and data, somewhat similar to the use of that term in object-oriented programming languages (e.g., instances of classes). Although instances are described herein, it will be understood that one or more instances may be replaced with separate OSs from a variety of manufacturers. A firmware instance exists for each of the plurality of soft partitions, wherein each firmware instance provides an IPF compatible firmware interface for the OS of its respective soft partition. For purposes of illustration and not limitation, firmware interfaces described herein may comprise an advanced configuration and power management interface (ACPI) module, extended firmware interface (EFI) module, system abstraction layer (SAL) module, and processor abstraction layer (PAL) module, and corresponding extensions of the same as defined by INTEL, by way of example but not limitation.

Each firmware partition provided in a soft partitioning system is compatible with industry standard interfaces (e.g., ACPI, SAL, EFI, PAL) and thus enables instances of well-behaved, standard IPF OSs to be implemented on such firmware partitions with minimal OS changes. In this sense, an OS is considered as well-behaved if it makes no assumptions about the hardware physical configuration, but instead relies solely or at least in large part upon the descriptions of the hardware provided to the OS through the industry standard firmware interfaces (e.g., EFI, SAL, and ACPI). Thus, an OS that is fully compatible with the IPF standards is well-behaved.

It will be understood that embodiments of a soft partitioning system may be applied not only to IPF-based systems, as in the specific examples described herein, but may similarly be applied for enabling soft partitioning of other types of systems in a manner that enables the pre-defined interfaces between an OS and the system firmware to be maintained such that modifications to the OS and/or underlying hardware are minimized for achieving soft partitioning. For example, non-IPF implementations where soft partitioning is desired for a computer that is not designed to support soft partitioning (e.g., insufficient hardware resources to divide up) may achieve a similar benefit.

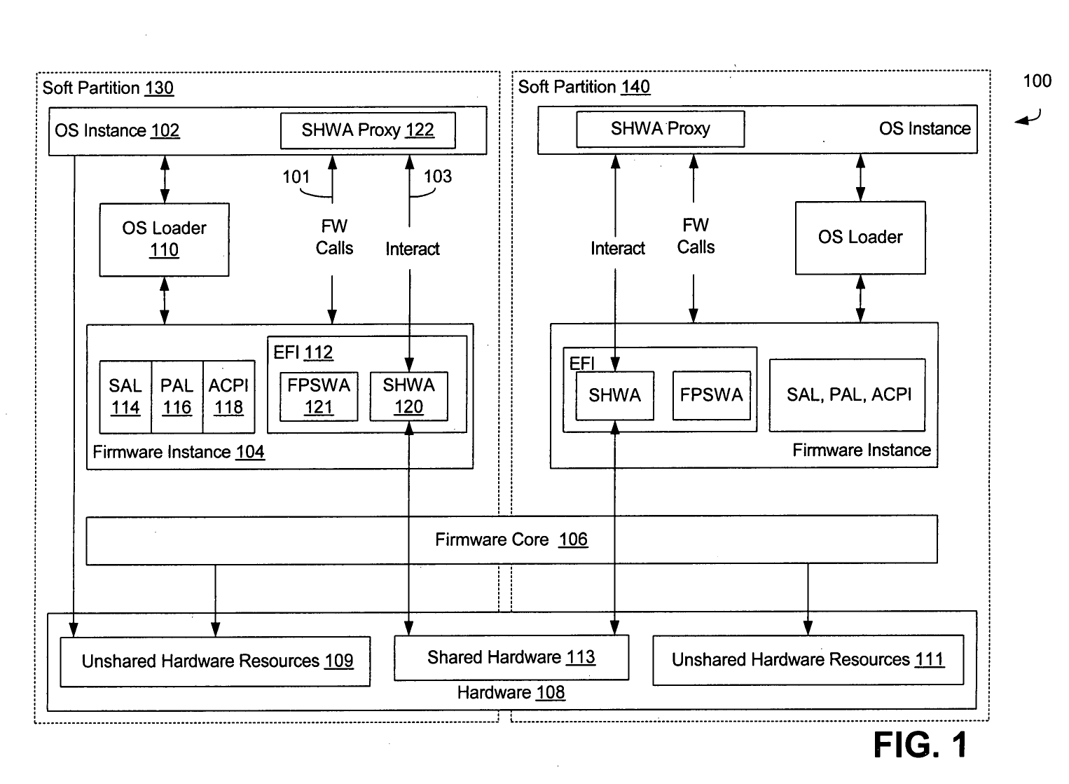

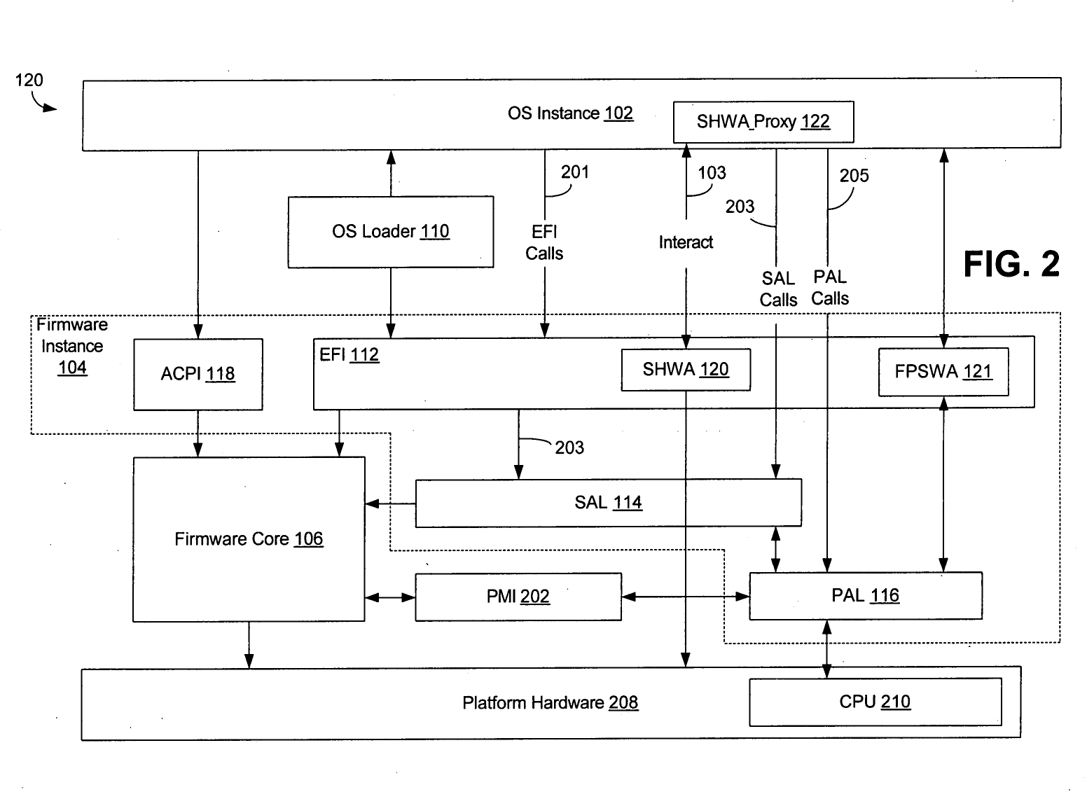

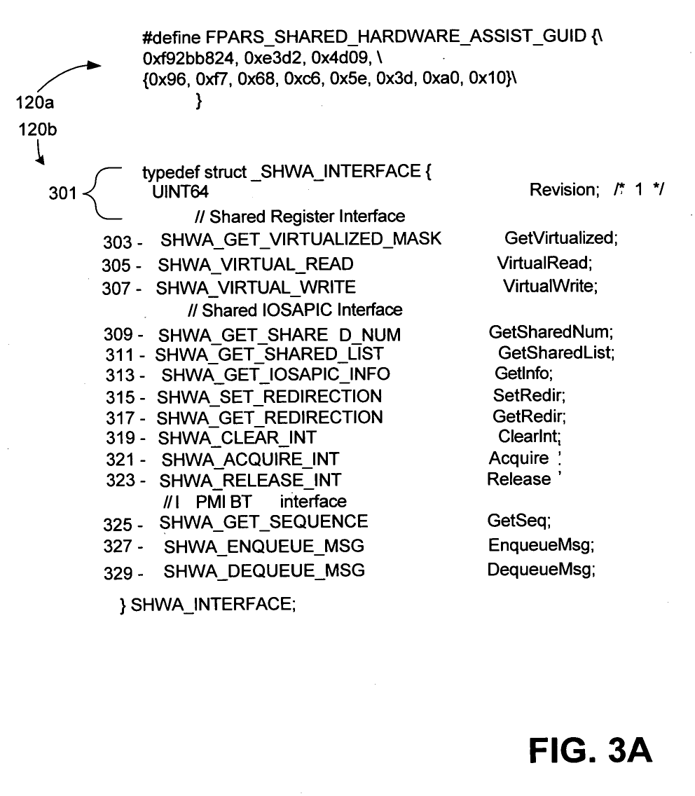

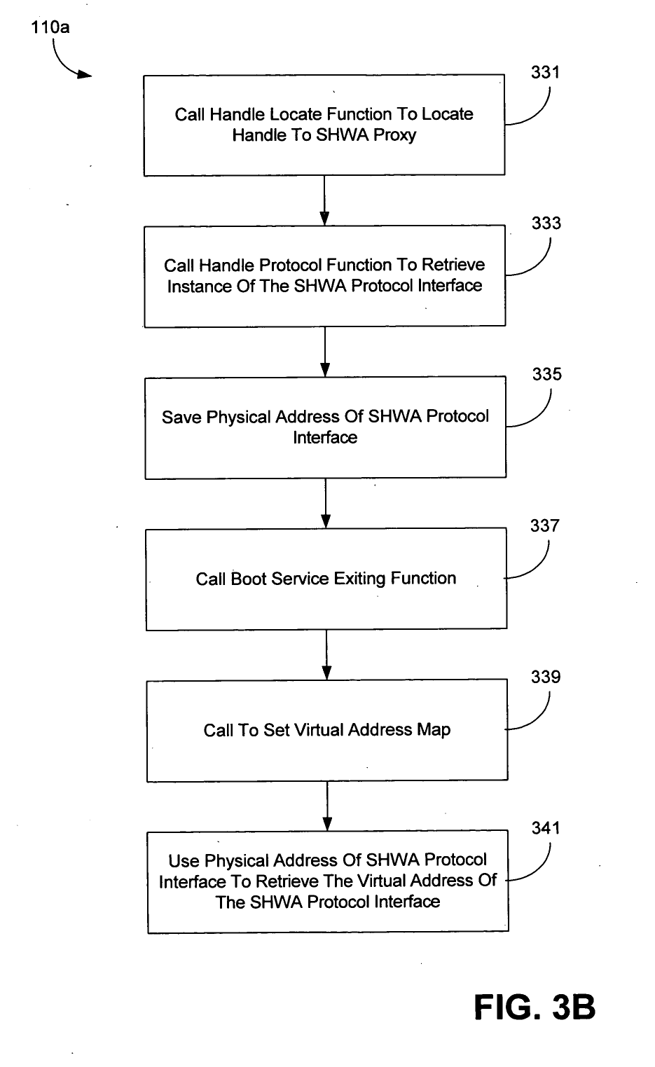

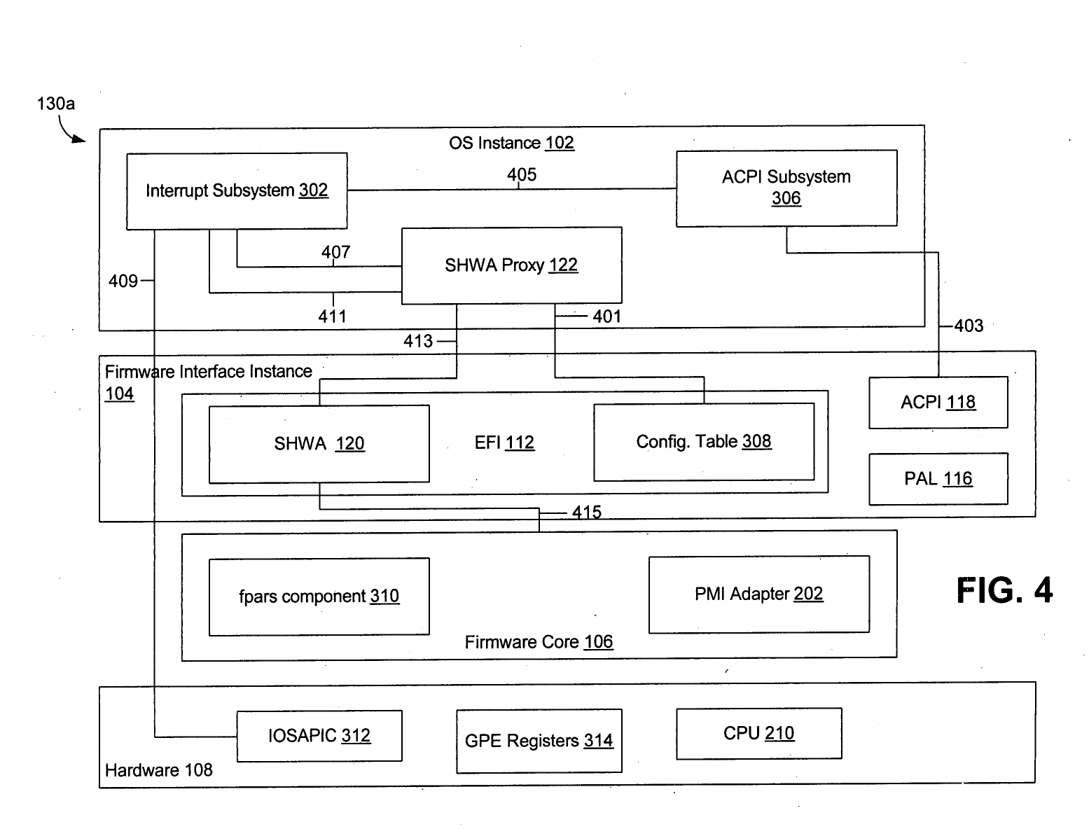

In the description that follows, FIG. 1 is used to illustrate an embodiment of a soft partitioning system shown with two soft partitions. FIG. 2 illustrates a soft partition embodiment. FIGS. 3A-3B illustrate an exemplary SHWA protocol interface structure and method for its initialization. FIGS. 4-7 are used to illustrate various mechanisms of various soft partition embodiments to initialize and use shared hardware resources.

FIG. 1 is a Unified Modeling Language (UML) diagram that illustrates an embodiment of a soft-partitioning system 100 that includes two exemplary soft-partitions 130 and 140. As soft partition 130 is essentially a mirror image of soft partition 140, further discussion of soft partition 140 is omitted. Soft partition 130 includes an OS instance 102, a firmware interface instance 104, a firmware core 106 shared among soft partitions 130 and 140, and hardware 108. Note that variations of the disclosed structure are possible, such as separate firmware cores corresponding to each OS instance. An OS loader 110 includes functionality that uses the firmware interface instance 104 to discover and initialize the soft partition 130. For example, the OS loader 110 may retrieve control of the processors of the hardware 108. Firmware calls are made between the OS instance 102 and the firmware interface instance 104, as represented by double-head arrows 101.

In one embodiment, the firmware interface instance 104 includes an extended firmware interface (EFI) module 112, a system abstraction layer (SAL) module 114, a processor abstraction layer (PAL) module 116, and an advanced configuration and power management interface (ACPI) module 118. The EFI module 112 includes a shared hardware (SHWA) protocol interface 120 that, in one embodiment, is incorporated via a floating point software assist (FPSWA) module 121. A FPSWA module 121 is an architected element that can be stored on disk and modified by a user, an OEM, etc. to provide new or improved functionality. The SHWA protocol interface 120 cooperates using standard EFI protocols with a SHWA proxy 122 that resides, in one embodiment, in the OS instance 102, to enable the sharing of hardware resources.

The SHWA protocol interface 120 provides a global view of the partitioned hardware to enable the correction of configurations and reconfigurations. The SHWA protocol interface 120 may configure a firmware partition database in, for example, non-volatile random access memory (NVRAM). In particular, a database or other data structure is stored as one or more EFI variables using an OEM-soft partition specific globally unique identifier (GUID) and name. The soft partition NVRAM definition of one or more EFI variables is employed by the firmware interface instance 104 to construct each firmware partition segment when booting. For example, if a single variable is created, its contents can represent an aggregate of configuration state variables (e.g., one byte of NVRAM per central processing unit (CPU)). As another example, each hardware resource that can be “owned” by a single OS instance can be represented by a separate EFI variable whose name is the same as the name of the hardware resource that the firmware core 106 describes in an ACPI namespace (described below). This provides a persistent storage copy of an aggregate database that holds the low-level hardware identity of assignable resources, such as memory chunks, processors, and I/O cards. This database may also contain policy variables.

In one embodiment, a reboot is used to allow the firmware core 106 to build a soft partition spanning namespace. The spanning namespace represents a descriptive database and behavior that comprises a union of each of the individual ACPI namespaces owned by separate soft partition instances and the firmware view of the hardware resources that exists as a single namespace. For example, a single CPU may appear to be physically present in each of the namespace instances, but is only enabled in one of them at one time. Thus, the ownership of a physical device is unique, but is only enabled in one of the soft partitions at a time. In other words, the ownership of a physical device is unique, but the possibility of ownership is universal among siblings (e.g., among soft partitions). ACPI tables are generated that provide an ACPI namespace that enables each soft partition instance (e.g., 130 and 140) to “see” all of the hardware resources of the hardware 108. This feature, in turn, enables peer-to-peer device migration to be implemented utilizing standard ACPI “hotplug” interfaces augmented with few modifications. This feature also enables each soft partition to build an inventory of all available hardware resources, including hardware resources “owned” by other soft partitions or presently unassigned to a particular soft partition. An ACPI namespace that exists if every hardware resource inside a soft partition is assigned to either a particular soft partition or a “draft pool” of hardware resources is generally referred to as a spanning namespace. That is, a spanning namespace may include an ACPI namespace that spans (i.e., includes all) of the hardware resources available to one or more soft partitions in a system. A backbone of each soft partition namespace may be identical to the backbone of the spanning namespace. A backbone generally refers to a device or devices in the ACPI namespace that are shared by every soft partition because it forms a framework upon which owned (or migratable) devices are attached. In one embodiment, an example of a backbone is a system bus adapter (SBA) which is an input/output (I/O) bus bridge that connects the system memory to various industry standard I/O hardware buses.

After one reboot, a global reboot (all processors in the hard partition) is not needed unless the spanning namespace is changed. The SHWA protocol interface 120 interacts with the SHWA proxy 122 of the OS instance 102 through interact calls 103. The interact calls 103 may include both interrupt and procedure call interactions.

The EFI module 112, SAL module 114, and PAL module 116 provide processor and system initialization for an OS boot, as described below. Additional or other firmware functionality may be provided by the same or other firmware components.

The core firmware 106 includes information identifying the resources across all soft partitions (e.g., software partitions 130 and 140), and the individual firmware instances (e.g., firmware interface instance 104) identify the resources available (assigned) to their respective soft partition (e.g., soft partition 130 for firmware interface instance 104). In one embodiment, the core firmware 106 is a Banyan architecture as described in the co-pending provisional application referenced in the cross-reference section of this application.

The hardware 108 includes all of the hardware components, including the system's processors, registers, and interrupt controllers. The hardware 108 includes hardware resources 109 dedicated to the soft partition 130, hardware resources 111 dedicated to soft partition 140, and shared hardware resources 113. In an exemplary embodiment described below, general purpose event (GPE) registers and input output streamlined advanced interrupt controllers (IOSAPICs) are discussed, with the understanding that other registers and interrupt controllers may be used.

FIG. 2 is a block diagram that further illustrates one soft-partition instance embodiment 130. In particular, the soft partition instance 130 includes components shown in FIG. 1, as well as some additional components, including firmware interface instance components such as a platform management interrupt (PMI) module 202 and hardware resource CPU 210. The FPSWA binary code of the FPSWA module 121 is loaded as an EFI driver before the OS is booted and remains resident in memory as a runtime library used by the OS kernel. Similarly, the SHWA protocol interface 120 is loaded as a boot-time loaded EFI protocol, which extends the functionality available to the OS instance 102. That is, in one embodiment, the SHWA protocol interface 120 remains a component of the firmware interface instance 104, but functionally becomes part of the OS instance 102 through the code of the SHWA proxy 122. The SHWA proxy 122 binds to the SHWA protocol interface 120 and exposes kernel-specific functions that then call the SHWA entry point. Also shown are EFI firmware calls 201, SAL firmware calls 203, and PAL firmware calls 205. The hardware 108 includes platform hardware 208, which may also include a main CPU 210. The main CPU 210 can be, for example, an INTEL ITANIUM processor.

In general, firmware programs memory controllers before processors may actually perform loads and stores to the memory. Thus, at boot time, the memory controllers are programmed so that all of main memory is available to processors (e.g., CPUs) for load/store operations, and memory is sliced-up so that each soft partition is the owner of a non-intersecting “chunk” of this global resource described in the ACPI namespace owned by a particular OS instance. In one embodiment, when the soft partition 130 is powered on, various system checks are implemented by administrative processors of the platform hardware 208, and then power and clocks are provided to the main processor (CPU) 210 to execute code of PAL module 116 to initialize the processor 210. Control is then passed from the PAL module 116 to the SAL module 114, which discovers what hardware resources are present and initializes the same to make the hardware resources available to the OS instance 102, primarily main memory (not shown). When main memory is initialized and functional, the code of the firmware interface instance 104 is copied into main memory. Then, control is passed to the EFI module 112, which is responsible for activating boot devices, such as a disk. For example, the EFI module 112 reads the disk to load code corresponding to the OS loader 110 into memory. The EFI module 112 loads the code corresponding to the OS loader 110 into memory, and then passes it control of the soft partition 130 by branching one of the processors of the platform hardware 208 into the entry point of the OS loader program 110.

The OS loader 110 uses the firmware interface instance 104 to discover and initialize the soft partition 130 further for control. For example, the OS loader 110 may retrieve control of all of the processors of the platform hardware 208 available to a particular soft partition 130, which may include some or all of the processors of the platform hardware 208. For example, in a server configured to boot with two soft partitions, each owning half of the processors in the platform hardware 208, the loader 110 may only retrieve control of the half of the processors that are configured to be owned by the particular soft partition. An OS loader in the other soft partition may retrieve control of the other half of processors. At this point, the other processors of the platform hardware 208 may be executing in do-nothing loops. In an ACPI compatible system, the OS instance 102 parses ACPI static tables of the ACPI module 118 to discover the other processors of the soft partition system 100 (FIG. 1) and compile ACPI device definition blocks (DDBs) in the tables into the ACPI “namespace” with ACPI machine language (AML) objects and methods. A device definition block may be a data structure that firmware can construct, the data structure including ACPI machine language that is compiled by an OS (as it reads and parses the ACPI tables at boot time) into the ACPI namespace for a particular OS instance (e.g., OS instance 102). Then, the OS instance 102 uses the firmware interface 104 to cause those discovered processors to branch into the operating system code. At that point, the OS instance 102 controls all of the processors, and the firmware interface instance 104 is no longer in control of the soft partition system 100. At runtime, the OS instance 102 interprets the ACPI namespace and interacts with its objects to perform various functional steps.

As the OS instance 102 is initializing, it discovers from the firmware interface instance 104 what hardware resources are present at boot time. And in the ACPI standards, the OS instance 102 also discovers what hardware resources can be present or added or removed at run-time. In discovering hardware resources that may be present in an ACPI-compatible system, the OS instance 102 accesses the system's ACPI tables. The OS instance 102 uses function calls, described below, during system initialization to find out the address of the ACPI tables. A pointer to those ACPI tables is passed to an EFI system table pointer, which is obtained by making an EFI procedure call 201. Thus, EFI procedure calls 201 are used to pass the address of the ACPI tables, which describe the hardware of the system 100. Such ACPI tables that the OS instance 102 accesses at boot time describe the resources available to the system 100.

The shared hardware service of the SHWA protocol interface 120, being an EFI protocol, employs standard EFI calling conventions, which may be referenced in section 2.3 of the EFI 1.10 specification as a review of a caller's responsibilities.

FIG. 3A is programming diagram of an exemplary header file that defines a SHWA protocol interface 120, including a GUID (Guaranteed Unique Identifier) 120a and a protocol interface structure 120b. As described further in the context of FIG. 3B, the GUID 120a is used as an argument parameter to a LocateHandle( ) function which is provided by the EFI layer. The LocateHandle( ) function returns a handle value that is then used in a subsequent HandleProtocol( ) function call. The HandleProtocol( ) function fills in a data structure with the function pointers defined in the protocol interface structure 120b. The GUID 120a is used to identify the SHWA protocol interface image, which has an architected binary structure built-in to read-only memory (ROM) or loaded from an EFI disk partition. The GUID 120a is also used to identify the SHWA protocol interface structure 120b. The SHWA protocol interface structure 120b includes a revision field and a number of entry points into the shared hardware protocol (collectively referenced by 301 in FIG. 3A).

With regard to SHWA_Get_Virtualized_Mask 303 (herein, function 303), this function 303 is a query function used by OS instance 102 (FIG. 1) to discover if there are any IPF standard registers that must be accessed virtually (using a SHWA Virtual_Read or Virtual_Write function, described below). Function 303 is implemented because the registers are shared by siblings (other soft partitions, such as soft partition 140), but the IPF standard implicitly requires these registers to be unshared. Thus, this function 303 provides a mechanism to surface this constraint to the OS. General purpose event (GPE) registers are shared registers in soft partition 130 and thus are to be accessed virtually through the SHWA protocol interface 120. However, GPE registers are described using a fixed ACPI description table (FADT). The FADT table provides no extension mechanism for soft partition firmware to explicitly indicate that the SHWA virtual register access procedures are to be employed when accessing the GPE registers described in the FADT. Therefore, this function 303 is used by soft partition aware OS software (e.g., OS instance 102) to query whether or not the GPE registers described in the FADT are to be accessed virtually. The function 303 is called when the SHWA proxy 122 is initially configured, before an ACPI subsystem is configured, so that the ACPI system can employ proper access. The function 303 returns a bit set to a 1 if virtualization of the root GPE registers must be used, and 0 otherwise. In one embodiment, the SHWA protocol interface 120 defines only one register set, ROOT_GPE_BLOCK (bit 0), because the other GPE registers are described in distributed GPE block devices in the ACPI namespace using original equipment manufacturers (OEM) extension mechanisms that can express the need for virtualized register access.

Parameters of the function 303 include UseVirtualAccess, which is a pointer to a mask variable that will be filled in by the function. Each defined bit in the mask identifies a register or register set whose access may or may not require virtualization through the SHWA protocol interface 120. If the bit is set, the named register requires virtualization. If it is not set, direct access (no virtualization by the SHWA protocol interface 120) is required. Undefined bits are reserved and are returned as zeros.

SHWA_Virtual_Read 305 (herein, function 305) is a function that reads a platform register resource using SHWA protocol interface semantics. The actual data returned may depend upon the resource type and partition configuration. For example, for a GPE status register, only bits that correspond to hardware resources owned by a caller are set, regardless of the actual values of the underlying register hardware. The function 305 takes on parameters AccessWidth, Size, and Buffer. AccessWidth specifies the size of the access to use when reading the register. Address specifies the address of the virtualized register being accessed. If the function 305 is called in physical mode, this is the physical address. If the function 305 is called in virtual mode, this is the virtual address that is covered by an OS-provided translation that is specified by an EFI function (i.e., SetVirtualAddressMap( )). Size specifies the number of bytes to read beginning at Address. Buffer specifies the address of the buffer into which the read data will be copied. The address may be naturally aligned to match AccessWidth. If the function 305 is called in physical mode, this is the physical address of a memory buffer. If the function 305 is called in virtual mode, this is the virtual address that is be covered by an OS-provided translation specified by EFI SetVirtualAddressMap( ).

SHWA_Virtual_Write 307 (herein function 307) is a function that writes a platform register resource using SHWA protocol interface semantics. The actual data written to the physical hardware may depend upon the resource type and partition configuration at the time of the write. The architecturally intended functional semantics within the segmented ownership scope of a soft partition architecture are guaranteed. For example, enabling a GPE interrupt bit allows a subsequent interrupt for that bit to be surfaced through a SCI interrupt and corresponding GPE status bit. Prior to enabling the GPE interrupt, the soft partition 130 (FIG. 1) will not get any interrupt from this device.

The function 307 includes parameters AccessWidth, Size, and Buffer. AccessWidth specifies the size of the access to use when storing the register. Address specifies the address of the virtualized register being accessed. If the function 307 is called in physical mode, then this is the physical address. If the function 307 is called in virtual mode, then this is the virtual address that is covered by an OS-provided translation specified by EFI SetVirtuatAddressMap( ). Size specifies the number of bytes to write beginning at Address. Buffer specifies the address of the buffer from which the write data is copied. The address may be naturally aligned to match AccessWidth.

SHWA_Get_Shared_Num 309 (herein function 309) provides a routine that may be used once at boot time within soft partition 130 (FIG. 1) prior to programming any IOSAPIC hardware described in the ACPI tables to discover how to size the return buffer parameter for SHWA_Get_Shared_List 311 (described below). The routine may be used again following a cell online-add-delete (OLAD) operation in which shared IOSAPICs may be added or removed so that correct sharing behavior may be observed.

Parameters of the function 309 include NumSharedIoSapics, which specifies the naturally aligned address of, for example, a UINT64 in INTEL architectures, to receive the return data. The value returned is the integer number (0 . . . N) of the number of IOSAPIC devices that are accessed using the shared IOSAPIC functions. If the function 309 is called in physical mode, then this is the physical address of the memory buffer. If the function 309 is called in virtual mode, then this is the virtual address that is covered by an OS-provided translation specified by EFI SetVirtualAddressMap( ).

SHWA_Get_Shared_List 311 (herein function 311) provides a routine that returns an array of shared IOSAPIC descriptions that allows the OS instance 102 (FIG. 1) to correctly configure and use these resources. This routine is called by the OS instance 102 to discover details about the set of shared IOSAPICS in the host device (e.g., server). Parameters include List and Size. List is a pointer to a buffer large enough to return an array of SHWA structures that describe all shared IOSAPICs. If the function 311 is called in physical mode, then this is the physical address of a memory buffer. If the function 311 is called in virtual mode, then this is the buffer's virtual address that is covered by an OS-provided translation specified by EFI SetVirtualAddressMap( ). Size, as an input, specifies in bytes the size of the buffer pointed to by List. As an output, the function 311 with the parameter Size returns the actual size of the complete IOSAPIC list. The buffer pointed to by List is sized by the size of a SHWA protocol interface descriptor structure multiplied by the number of shared IOSAPICS returned by the previous routine. The data returned contains the physical address of every shared IOSAPIC that is to be programmed/accessed using the remaining 6 shared IOSAPIC procedures (described below) and a bitmask identifying the interrupt access model: for shared use (0) vs. exclusive use (1) interrupt. In one implementation, the bitmask is 256 bits (4×64) and supports the architected maximum of IOSAPIC redirection registers. Bit position 0 (little endian) of ExclusiveAccessMode[0] corresponds to redirection register 0, and bit 63 of ExclusiveAccessMode[3] corresponds to redirection register 255. Note that various redirection register quantities or types may be used.

SHWA_Get_IOSAPIC_Info 313 (herein function 313) returns the contents of the version register of the specified shared IOSAPIC. This function 313 returns the contents of the IOSAPIC version register in the same format as the actual register. The essential data in this return value is the number of redirection entries provided in the IOSAPIC because this value is used to index into a GSI space defined by an ACPI table entry (e.g., the MADT entry) for the IOSAPIC. The ACPI tables map each functioning interrupt in the IOSAPIC to the device using that interrupt. Parameters include IoSapicAddress and Version. IoSapicAddress specifies the address of the shared IOSAPIC whose version register contents are to be returned. If the function 313 is called in physical mode, then this is the physical address of the IOSAPIC. If the function 313 is called in virtual mode, then this is the IOSAPIC's virtual address that is covered by an OS-provided translation specified by EFI SetVirtualAddressMap( ). Version is a pointer to the location in which firmware returns a copy of the contents of the IOSAPIC version register. If the function 313 is called in physical mode, then this is the physical address of the memory buffer. If the function is called in virtual mode, then this is the buffer's virtual address that is covered by an OS-provided translation specified by EFI SetVirtualAddressMap( ).

SHWA_Set_Redirection 315 (herein function 315) provides a routine used by the OS instance 102 (FIG. 1) to program one of the shared IOSAPIC redirection registers. If the register is exclusive access, the value is atomically written to the actual register. Mutual exclusion access in a multiprocessing environment generally means that only one processor may perform a read-modify-write access at a time. Other processors are held off from such access so that they cannot read a data value that will immediately become stale. If the register is shared access, the value is written to the virtualized redirection register (since the actual register is controlled by firmware so it can use a PMI interrupt). Parameters include IoSapicAddress, RedirNumber, and RedirValue. IoSapicAddress specifies the address of the shared IOSAPIC whose redirection register is to be programmed. If the function 315 is called in physical mode, then this is the physical address of the IOSAPIC. If the function 315 is called in virtual mode, then this is the IOSAPIC's virtual address that is covered by an OS-provided translation that is specified by EFI SetVirtualAddressMap( ). RedirNumber selects the redirection register within the shared IOSAPIC to be programmed. If the interrupt is shared, the virtualized redirection value is programmed. If the interrupt is unshared (exclusive) and a caller has acquired ownership of this register, the actual register will be programmed. RedirValue is a pointer to the location which contains the value to program into the redirection register. If the function 315 is called in physical mode, then this is the physical address of the memory buffer. If the function 315 is called in virtual mode, then this is the buffer's virtual address that is covered by an OS-provided translation specified by EFI SetVirtualAddressMap( ).

The function 315 atomically programs the virtualized (shared) or actual (unshared) IOSAPIC redirection register number indicated by RedirNumber {0 . . . MaxRedir} with the RedirValue. The actual control and status register (CSR) programming model may require a critical section with multiple 32-bit stores, whereas this routine abstracts that detail.

One embodiment of the SHWA protocol interface 120 only virtualizes interrupts for shared redirection entries: the ACPI SCI entry of any cell and the IPMI block transfer (BT) entry of the root cell IOSAPIC.

For these shared entries, the firmware core (e.g., PMI adapter 202) itself programs the physical redirection register with a PMI level interrupt targeting a CPU chosen by firmware. It multiplexes this interrupt to each sibling soft partition using information passed into firmware using this procedure. Specifically, the target CPU (ID, EID) and the interrupt vector chosen by the OS instance 102 (FIG. 1) sends an IPI interrupt with the appropriate level to the OS-specified CPU when the interrupt occurs, in one embodiment, if and only if the OS instance 102 should receive the interrupt. For example, if only one GPE bit is set, only one soft partition gets the interrupt. If multiple GPEs are set at the time the PMI interrupt handler executes, each soft partition owning a set bit will receive a virtualized IOSAPIC interruption. When the GPE is delivered into the ACPI interrupt handler, the interpreter uses the ReadVirtual( ) procedure which calls into the SHWA service instead of direct instruction (read byte) access. Each soft partition “sees” or encounters a virtualized (filtered) register value that never exposes set bits for GPE bits not owned by the soft partition at the time of the ReadVirtual( ) call. As ownership of devices and their corresponding GPE bits changes through yielding and claiming (migrating) devices, the virtualized (filtered) view adapts. A bit that previously would never be set is now seen to be set.

Firmware may choose any CPU it deems suitable to perform PMI handling and may change the designated CPU during operation. For example, during local machine check abort (MCA) processing within one soft partition (e.g., soft partition 130, FIG. 1), the target CPU for SCI interrupt may be moved to a CPU in a different soft partition (e.g., soft partition 140, FIG. 1). Such changes are implementation dependent and abstracted (hidden) from the OS instance (e.g., OS instance 102).

In one embodiment, function 315 does not support virtualized sharing of one or more of the entries. For these entries, only one soft partition may safely program them at a time. Firmware provides an acquire/release interface (described below in 321 and 323) to allow this usage. For example, one soft partition may want to program the platform timers implemented in a cell controller for performance data collection. Such resources depend upon exclusive use by one partition for their value. This routine may also be used for programming exclusive access redirection registers, wherein the OS instance that owns exclusive rights to a redirection register does not program that register directly. This routine is used to abstract a lock that guarantees serialization through all shared IOSAPIC register accesses.

SHWA_Get_Redirection 317 (herein function 317) is a function that atomically reads the virtualized (shared) or actual (unshared) IOSAPIC redirection register number indicated by RedirNum {0 . . . MaxRedir}, returning the value in RedirValue. Shared interrupts return a virtualized register value that is synthesized by firmware. Unshared interrupts return the actual redirection register value. The actual CSR programming model requires a critical section with multiple 32-bit stores, whereas this routine abstracts that detail.

If the interrupt specified by RedirNumber is shared, the virtualized register value is returned. If the interrupt is exclusive access, the actual hardware value of that register is returned. In either case, the code performing the access is serialized with all other similar accesses.

One embodiment of the SHWA protocol interface 120 only virtualizes interrupts for shared redirection entries: the ACPI SCI entry of any cell and the IPMI BT entry of the root cell IOSAPIC.

The routine provided by function 317 is used to abstract a lock that guarantees serialization through all shared IOSAPIC register accesses while also providing functionality of virtualized (shared) interrupt behavior and real (unshared) interrupt control to the soft partition operating systems.

Parameters include IoSapicAddress, RedirNumber, and RedirValue. IoSapicAddress is the address of the shared IOSAPIC whose redirection register is to be programmed. If the function 317 is called in physical mode, this is the physical address of the IOSAPIC. If the function 317 is called in virtual mode, this is the IOSAPIC's virtual address that is covered by an OS-provided translation specified by EFI SetVirtualAddressMap( ). RedirNumber selects the redirection register within the shared IOSAPIC to be read. If the interrupt is shared, the virtualized redirection value is returned. If the interrupt is unshared (exclusive) and the caller has acquired ownership of this register, the actual register value will be returned. RedirValue is a pointer to the location in which firmware returns the value from the selected redirection register. If the function 317 is called in physical mode, then this is the physical address of the location. If the function 317 is called in virtual mode, then this is the location's virtual address that is covered by an OS-provided translation specified by EFI SetVirtualAddressMap( ).

SHWA_Clear_Int 319 (herein function 319) provides a routine that is used by the OS instance 102 (FIG. 1) to write a shared EOI register to clear an interrupt for a virtualized (shared) redirection register or an actual (unshared) redirection register to complete interruption processing following receipt of an interrupt from the register. Calling this routine writes the virtualized EOI register for shared interrupts and the actual EOI register for unshared interrupt. The routine is called when the OS kernel would have written the EOI register when a processor receiving the interrupt has finished servicing an interrupt from the IOSAPIC. In one implementation, among other possible implementations, an actual EOI value may contain only an 8 bit interrupt vector value. However, because the firmware 104 and 106 (FIG. 1) are not able to implement an exact IOSAPIC model, and because sibling soft partitions may choose the same vector number to target their different CPUs for interrupt handling, the RedirNumber parameter is used to disambiguate shared EOIs from each other. If the specified interrupt is unshared and access rights are held, then the actual EOI register will be atomically written with the provided EoiValue.

Parameters include IoSapicAddress, RedirNumber, and EoiValue. IoSapicAddress is the address of the shared IOSAPIC whose redirection register is to be programmed. If the function 319 is called in physical mode, this is the physical address of the IOSAPIC. If the function 319 is called in virtual mode, this is the IOSAPIC's virtual address that is covered by an OS-provided translation specified by EFI SetVirtualAddressMap( ). RedirNumber selects the redirection register within the shared IOSAPIC that corresponds to the interrupt being cleared. This parameter helps the firmware provide virtualization of the resource. EoiValue is a pointer to the location that contains the value to program into the virtualized EOI register. If the function 319 is called in physical mode, this is the physical address of a memory buffer. If the function 319 is called in virtual mode, this is the buffer's virtual address that is covered by an OS-provided translation specified by EFI SetVirtualAddressMap( ).

SHWA_Acquire_Int 321 (herein function 321) is a function that supports exclusive use (by a single soft partition, such as soft partition 130, FIG. 1) of individual redirection registers within a shared IOSAPIC. For unshared IOSAPIC interrupts, only one soft partition may program the redirection register at a time. The soft partition, if it successfully called this routine, grants access rights to that interrupt. The rights are granted on a first-come-first-serve basis. In one implementation, only the soft partition owning rights to a particular IOSAPIC redirection register may use that register by calling the three previously described function routines (i.e., of 319, 317, and 315). When a soft partition is destroyed, reset or otherwise incapacitated (so that no OS software can or will be able to release rights), firmware core 106 (e.g., PMI adapter 202) automatically releases exclusive access rights held by that soft partition.

Parameters include IoSapicAddress and RedirNumber. IoSapicAddress is the address of the shared IOSAPIC containing the redirection whose exclusive access is being requested. If the function 321 is called in physical mode, this is the physical address of the IOSAPIC. If the function 321 is called in virtual mode, this is the IOSAPIC's virtual address that is covered by an OS-provided translation specified by EFI SetVirtualAddressMap( ). RedirNumber selects the redirection register within the shared IOSAPIC for which exclusivity is being requested.

SHWA_Release_Int 323 (herein function 323) is a function used by the OS instance 102 (FIG. 1) to release exclusive access rights previously granted when it successfully acquired them with SHWA_Acquire_Int 321. In other words, a soft partition that owns exclusive use access rights to an interrupt in a shared IOSAPIC (having previously successfully called SHWA_Acquire_Int), releases those rights by calling this routine 323. For unshared IOSAPIC interrupts, only one soft partition may program the redirection register at a time. When a soft partition is destroyed, reset or otherwise incapacitated (so that no OS software can or will be able to release rights), the firmware core 106 automatically releases exclusive access rights held by that soft partition.

Parameters include IoSapicAddress and RedirNumber. IoSapicAddress is the address of the shared IOSAPIC containing the redirection whose exclusive access is being released. If the function 323.1s called in physical mode, this is the physical address of the IOSAPIC. If the function 323 is called in virtual mode, this is the IOSAPIC's virtual address that is covered by an OS-provided translation specified by EFI SetVirtualAddressMap( ). RedirNumber selects the redirection register within the shared IOSAPIC for which exclusivity is being requested.

SHWA_Get_Sequence 325 (herein function 325) is a function that returns one virtualized IPMI message sequence number to be used by a caller when handling IPMI messages sent and received through the interface functions SHWA_Enqueue_Msg 327 and SHWA_Dequeue_Msg 329, described below. This function 325 returns a virtualized message sequence number guaranteed to be globally unique among all soft partitions created since a cold boot. This is not the actual sequence number used in the message programmed into the hardware, which in one implementation is only 8 bits, but is a value used by the firmware core 106 to manage the correct routing of IPMI response messages. In one embodiment, the allocated virtualized sequence number is used with one and only one SHWA_Enqueue_Msg 327 procedure call and never reused. An OS may call this function 325 on an as needed basis, or it may call it many times, batching allocation of sequence numbers inside the OS instance 102 (FIG. 1) and then consuming them one at a time as it calls SHWA_Enqueue_Msg 327. In one implementation, an allocated sequence number should not be reused. An OS instance is not required to use all the sequence numbers it allocates.

Parameters include SequenceNum, which is a pointer to the location in which firmware returns a sequence number that is guaranteed to be unique (not to match that allocated to or in use by any other soft partition). If the function 325 is called in physical mode, this is the physical address of the location. If the function 325 is called in virtual mode, this is the location's virtual address that is covered by an OS-provided translation specified by EFI SetVirtualAddressMap( ).

SHWA_Enqueue_Msg 327 (herein function 327) is a function that is used to enqueue an IPMI BT message to shared BT hardware. Note that IPMI is a standard that supports different programming models, including keyboard (KB), system management controller (SMC), and block transfer (BT). Although described using block transfer, it will be understood that the soft partitioning systems described herein can be used with SMC and/or KB hardware. If a soft partition enables the IPMI BT interrupt using the shared interrupt interfaces, the receipt of the matching response message from the IMPI hardware will assert that interrupt. This function 327 enqueues a message to the IPMI hardware. If the hardware is not busy, the message is programmed immediately into the hardware before returning. If the hardware is busy, this message can compete for the hardware in a first-come-first-serve, round-robin basis among all soft partitions. The interrupt handler processes not only receipt messages but also may dequeue messages. The thread that calls this function may also be used to program previously enqueued messages not yet sent into the hardware. In this way, forward progress is assured even though firmware has no guarantee of periodic execution.

The message field containing the sequence number can contain, in one implementation, any 8 bit value because this value will not be used when firmware (e.g., SHWA interface 120 or PMI adapter 202) programs the BT interface. Instead, the internal sequence number used by firmware to share this interface will be programmed into the message. SequenceNum and the actual 8 bit sequence number are remembered in firmware data until the matching response is retrieved from the BT interface. In one embodiment, due to the IPMI BT interface architecture, there can be no more than 256 outstanding IPMI messages in a hard partition (among all soft partitions) at one time. There is an implementation dependent, per-soft partition limit of the maximum number of IPMI messages that may be enqueued into the SHWA protocol interface 120 at one time. When this maximum is reached, an EFI status message EFI_OUT_OF_RESOURCES is returned. The number of outstanding messages is reduced when the caller uses SWA_Dequeue_Msg 329 to retrieve the IPMI BT response.

Parameters include SequenceNum, BtMessage, and Size. SequenceNum specifies the virtual sequence number that the SHWA protocol interface 120 uses to associate the IPMI response message returned by management processor (MP) software. In one embodiment, this is a use-once value that is returned when the IPMI response message that corresponds to this message is dequeued. BtMessage is a pointer to a buffer containing one properly formed (e.g., standards compliant) IPMI BT message. If the function 327 is called in physical mode, this is the physical address of a memory buffer. If the function 327 is called in virtual mode, this is the buffer's virtual address that is covered by an OS-provided translation specified by EFI SetVirtualAddressMap( ). Size specifies the number of bytes in a BT message buffer.

SHWA_Dequeue_Msg 329 (herein function 329) is a function that is used to retrieve an IPMI BT response message from shared BT hardware. If the soft partition enables the IPMI BT interrupt using the shared interrupt interfaces, the receipt of the response messages destined for a soft partition will assert the IPMI interrupt programmed by the soft partition. Alternatively, an OS instance may periodically poll the interface using this function 329. This function 329 dequeues the next (in order) IPMI message destined for the calling from the IPMI BT hardware or the internal queue of previously retrieved messages. The function 329 returns the virtualized sequence number associated with this message, though the actual sequence number used for the message can be found inside the returned buffer. If the hardware is busy, this message can compete for the hardware in a first-come-first-serve, round-robin basis among all soft partitions. The interrupt handler processes not only receipt messages but also may dequeue messages into the internal buffers. The thread that calls this function 329 may also be used to program previously enqueued messages not yet sent into the hardware. In this way, forward progress is assured even though firmware has no guarantee of periodic execution.

Parameters include SequenceNum, BtMessage, and Size. SequenceNum is a pointer to a location that firmware (e.g., SHWA protocol 120 or PMI adapter 202) will write the virtualized sequence number that is associated with the IPMI response message. BtMessage is a pointer to a buffer that is large enough to receive an IPMI BT message. If the function 329 is called in physical mode, this is the physical address of the memory buffer. If the function 329 is called in virtual mode, this is the buffer's virtual address that is covered by an OS-provided translation specified by EFI-SetVirtualAddressMap( ). Size, on input, is a pointer to a location that specifies the maximum number of bytes in the BT message buffer that can hold the received message. On output, firmware (e.g., 120 or 202) writes the size of the actual BT message copied into the caller's buffer if the status indicates success. If the status indicates that the buffer is too small, the function 329 returns the size of the next message that will be dequeued if the caller provides a large enough buffer. If no messages were available, a status message such as EFI_NOT_FOUND is returned as the status and this parameter is set to zero.

FIG. 3B is a flow diagram that illustrates a method 10a to initialize the SHWA protocol interface 120. The OS Loader 110 (or an OS kernel) may perform the following procedure to perform this initialization. Initially, the loader 110 calls a handle locate function to find the handle to the SHWA proxy 122 (331). A handle protocol function is called to retrieve the SHWA protocol interface 120 (333), and then the physical address of the SHWA protocol interface 120 is saved (335). The value of the SHWA protocol interface 120 is a physical pointer to the SHWA protocol interface 120. This value is saved so that the SHWA handler entry point may be extracted at a later time. Once the physical address of the SHWA interface is obtained by the OS loader 110 (FIG. 1) (or OS initialization code in some embodiments), the OS loader 110 calls an ExitBootServices( ) function and sets up the appropriate virtual mapping for the SHWA protocol interface 120 (and rest of the EFI protocol) using a SetVirtualAddressMap( ) function. Once ExitBootServices( ) and SetVirtualAddressMap( ) have been called, the SHWA proxy 122 will be at its new virtual address, and the SHWA protocol interface structure 120b (FIG. 3A) will contain the virtual addresses of the entry points of each procedure within the protocol. The OS instance 102 (FIG. 1) (e.g., SHWA proxy 122) can use these entry points to call each of the SHWA protocol procedures defined above in association with FIG. 3A.

Continuing, a boot service exiting function is called (337), and a call is made to set the virtual address map (339). The physical address of the SHWA protocol interface 120 is used to retrieve the virtual address of the SHWA protocol interface entry point (341), after which the shared hardware protocol is enabled (and thus can begin implementation).

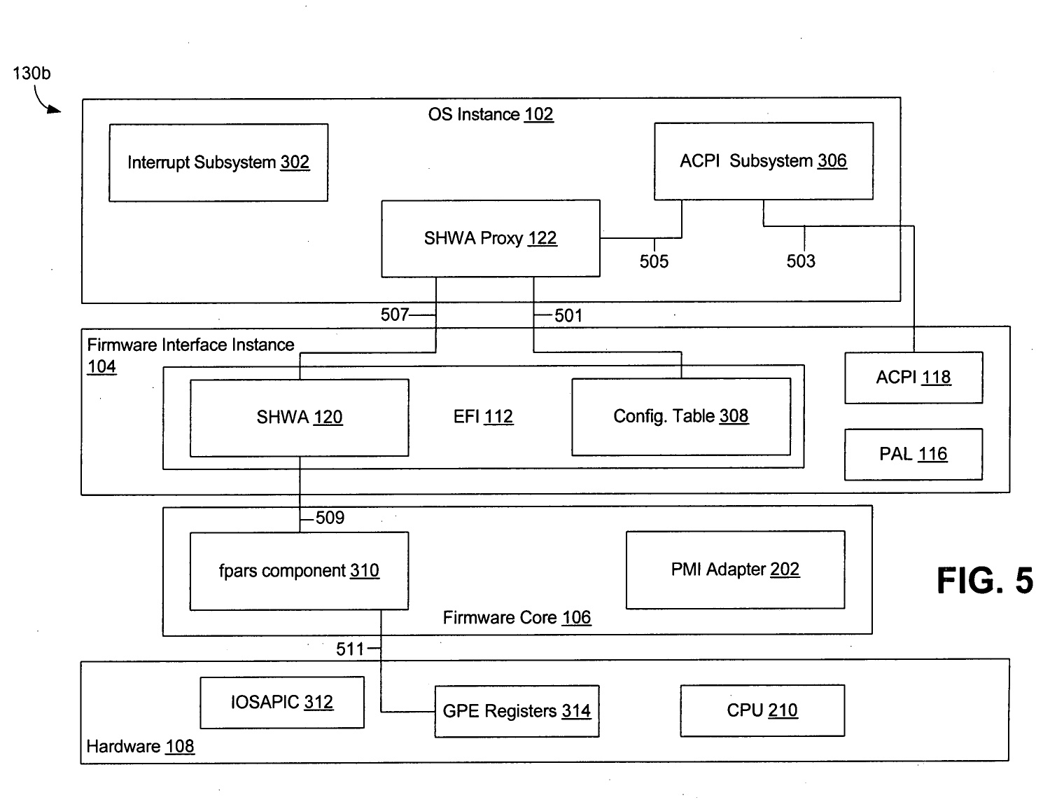

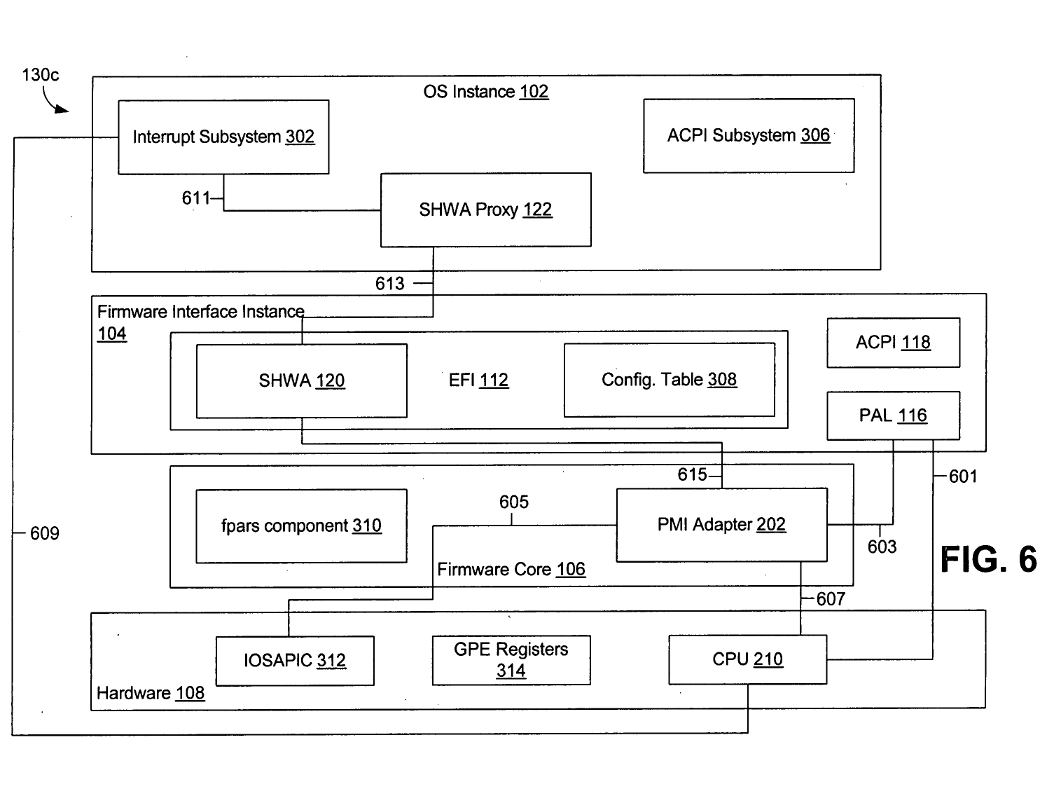

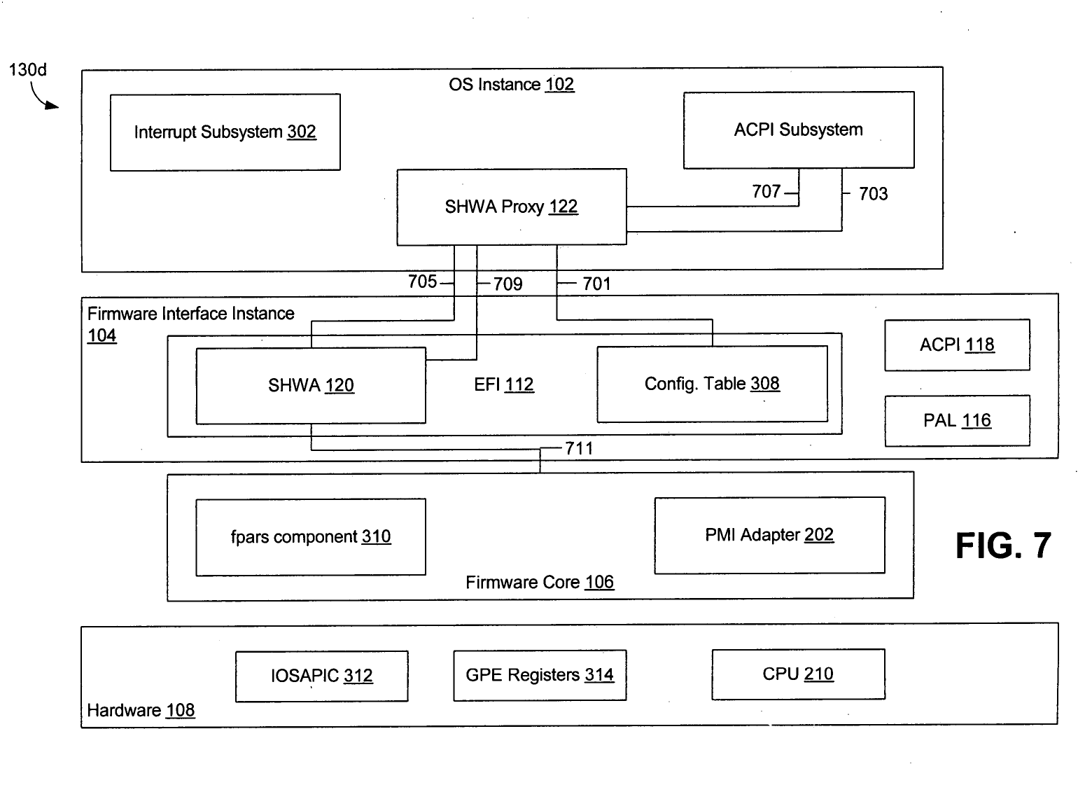

FIGS. 4-7 are UML collaboration diagrams that show various exemplary SHWA protocol procedural interfaces in collaboration with the OS instance 102. In particular, FIG. 4 illustrates initialization of SCI interrupt(s) during an OS boot. FIG. 5 illustrates initialization of the “virtual” GPE registers in the ACPI subsystem. FIG. 6 illustrates receipt and dispatch of an SCI GSI interrupt. FIG. 7 illustrates handling of a GPE interrupt by the ACPI interpreter when the SCI is received. Referring to FIG. 4, shown is a soft partition embodiment 130a that includes the OS instance 102, the firmware interface instance 104, the firmware core 106, and the hardware 108. The OS instance 102 includes an interrupt subsystem 302, a SHWA proxy 122, and an ACPI subsystem 306. The SHWA proxy 122 is a kernel-level device driver that is aware of the soft partition functionality and corresponding firmware interfaces. The SHWA proxy 122 is an interface module that is kernel-specific, and which adapts the code in the kernel that normally directly programs the hardware to the shared hardware protocol (e.g., SHWA protocol interface 120), which actually programs the hardware and provides sharing capability that the normal code cannot do. Thus, the SHWA proxy 122 functions as an adapter between the OS instance 102 and the SHWA protocol interface 120. The SHWA protocol interface 120 provides a mechanism to share hardware resources while involving minimal OS-firmware collaboration since the semantics of the SHWA protocol interface 120 is designed to cooperate with the OS at a level of abstraction that corresponds very closely to the low-level software already existing in the OS that has exclusive use of the hardware resources. The firmware interface instance 104 includes the EFI module 112, the ACPI module 118, and the PAL module 116. The EFI module 112 includes the SHWA protocol interface 120 and a configuration table 308. The firmware core 106 includes a firmware partition component 310, which can be part of the SAL module 114, and the PMI adapter 202, which is also part of the SAL module 114. The hardware 108 includes an IOSAPIC interrupt controller 312, GPE registers 314, and the main CPU 210.

An embodiment of an IOSAPIC initialization process is shown, with eight pertinent functions in the process indicated by reference numbers 401-415. It will be understood that variations in the processes described in FIGS. 4-7 may occur depending on the operating system utilized. For the examples illustrated in FIGS. 4-7, an O.S. instance 102 corresponding to an HPUX operating system is used for purposes of illustration and not limitation. In general, several high level goals of this sequence include acquiring the IOSAPIC address descriptions from an ACPI table of the ACPI module 118 (e.g., ACPI MADT), installing support primitives to use the SHWA protocol service if it is present, discovering which of these IOSAPICs are to be accessed through virtualized firmware partition services, programming those IOSAPICs that are non-virtualized using a standard programming model, and programming those IOSAPICs that are virtualized using firmware interface extensions (e.g., the SHWA proxy 122). Thus, initialization of the IOSAPICS through the firmware interface instance 104 obviates the need for each O.S. instance (e.g., 102) to program the IOSAPICs directly.

The above goals may be accomplished by the process or method embodiment 130a illustrated by the UML diagram shown in FIG. 4. The SHWA proxy 122, which is a firmware partition-enabled OS kernel module, is a proxy to the SHWA protocol interface 120, which provides an EFI protocol in one embodiment. After the SHWA proxy 122 is initialized, SHWA proxy 122 queries the firmware configuration table 308 to look for the SHWA protocol interface GUID in the protocol list (401). If this service is not found, the firmware 104 and/or 106 is not virtualizing the IOSAPIC hardware registers. If it is found, the SHWA proxy 122 saves the protocol entry point to be used later by the interrupt subsystem 302 when interacting with the IOSAPICs identified by (409). The SHWA proxy 122 and the ACPI subsystem 306 parse the interrupt controller descriptions inside the ACPI tables of ACPI module 118, building knowledge of all of the IOSAPICs described in an ACPI table (e.g., a static multiple APIC description table, or MADT) (403). There is generally no indication in the ACPI tables regarding the sharing or non-sharing nature of the IOSAPIC devices described therein. The interrupt subsystem 302 queries the ACPI subsystem 306 to discover the set of IOSAPICs that it is to initialize (405). The interrupt subsystem 302 queries the SHWA proxy 122 through a function call (407), the query conditional on whether a SHWA protocol service is discovered in the EFI configuration tables 308. For example, the interrupt subsystem 302 invokes a function call, and if this function is successful and returns 0, then there are no shared IOSAPICs and normal IOSAPIC initialization may proceed to (409). Otherwise, if the function returns a value greater than 0, the processing is complete. Thus, an enabled OS instance 102 may write software that works in a server that includes the SHWA protocol interface 120 as well as one that does not have this interface.

An array of shared IOSAPIC descriptors sized by the value returned in (407) is allocated and a function call is made to obtain the identities (physical address) of each IOSAPIC that is subsequently to be programmed through the virtualized interface instead of a direct CSR interface. In one embodiment, attributes of up to 64 redirection registers per IOSAPIC may be returned for each shared IOSAPIC so that the OS instance 102 may distinguish shared GSI interrupts from exclusive use GSI interrupts. The attribute data may be saved for reuse.

The interrupt subsystem 302 programs all of the unshared IOSAPICs (409). If no SHWA protocol interface 120 is present (ascertained from 403), this programming will be for every IOSAPIC and initialization is complete at this point. If the SHWA protocol interface 120 was discovered, and shared IOSAPICs exist, then execution proceeds to 411 to initialize them.

One or more function calls may be made to initialize each shared IOSAPIC interruption that the OS instance 102 wishes to initialize (411). For unshared GSI devices, the interrupt subsystem 302 acquires exclusive access on a per interrupt, per IOSAPIC basis before using a function call to program each interrupt. A function call may be used to acquire access rights. If access is granted, then a function that sets redirection registers will succeed, else it will fail.

In 413, internal interactions between the SHWA proxy 122 and the SHWA protocol interface 120 occur for global locks and state related to soft partition behavior. In other words, when the SHWA proxy 122 makes a procedure call into its copy of the protocol (i.e., the SHWA protocol interface 120) (413), the firmware internally competes for access to critical data and registers using hidden (internal) mutual exclusion locks (not shown but implied in the shared hardware 113 (FIG. 1)) that reduce the interface/interaction to making a function call (as opposed to steps that may include attempts to acquire a lock until successful, making the function call, and then releasing the lock). These interactions occur each time the SHWA proxy 122 invokes a SHWA protocol procedure that is transparent to the OS instance 102. In 415, interactions between the SHWA protocol interface 120 and the firmware core 106 occur that virtualize the IOSAPIC hardware functions. In particular, the PMI adapter 202 collaborates with the SHWA protocol of the SHWA protocol interface 120 and the SHWA proxy 122 to virtualize the functionality in the IOSAPIC controller 312 so that sharing of otherwise architecturally unsharable registers is possible. The PMI adapter 202 exists as a single copy in the firmware core 106 and may include PMI interrupt handlers as well as the state variables that manage the virtualized redirection registers. As in 413, the interactions in 415 are transparent to the OS instance 102.

FIG. 5 is a UML diagram that illustrates a method embodiment 130b for GPE register initialization. GPE register initialization is performed, for example, to enable sharing of this hardware resource among other OS instances. In one embodiment, a goal of the below described method 130b includes installing support primitives to use a SHWA protocol service if it is present. If a SHWA protocol service is present, another goal may be to adjust the resource type of the GPE registers described in the fixed ACPI hardware description table (FADT) so that these registers use virtual register shared hardware functions. Additional goals may include initializing the ACPI GPE registers using normal ACPI algorithms, the only difference being handled by the low-level access primitives in an ACPI file where the resource type selects among different OS layer primitives.

Once the SHWA proxy 122 is initialized, it queries the firmware configuration table 308 to look for the SHWA protocol interface GUID in the protocol list (501). If this service is not found, no shared hardware resource needs virtualized access. If it is found, the SHWA proxy 122 saves the protocol entry point to be used later by the ACPI subsystem 306 when accessing GPE registers 314 whose resource type may be an OEM-defined resource.

The SHWA proxy 122 and the ACPI subsystem 306 parse the ACPI tables of the ACPI module 118, building knowledge of all of the GPE registers 314 described by the firmware interface instance 104 (503). For each GPE register byte (which is architecturally byte-access), the bits are initialized and enabled using virtualized access primitives in the SHWA proxy 122 (505). The firmware instance 104 does not actually touch (e.g., access, such as by CPU load or store instructions) the hardware 108 at this time because the physical registers will have been previously initialized by the SHWA protocol interface 120. However, as each interrupt bit is initialized and enabled by the OS instance 102, those bits that correspond to hardware 108 that is owned by a soft partition (e.g., soft partition 130) making the register access will be enabled so that the interrupt may be enabled to be delivered should one occur. The OS instance 102 need not know which bits correspond to which device behavior, since one purpose of GPE bits is to abstract these details. The firmware instance 104 knows both which bits correspond to which hardware resource(s) and which hardware resource(s) corresponds to which soft partition. Only interrupts that belong to the soft partition 130 will be delivered to the soft partition 130. No spurious GPE interrupts will occur as a consequence of soft partition virtualization of GPE interrupts and registers.

When the OS instance 102 needs to program an IOSAPIC register that is shared, it makes a function call to the SHWA proxy 122, which then makes an EFI protocol procedure call (507) implemented in the SHWA protocol interface 120. The code in the SHWA protocol interface 120 can then make function calls into the firmware core 106, or directly access the hardware 108 after acquiring serialization. The code in the SHWA protocol interface 120 creates the illusion of exclusive access to an interrupt when the interrupt is actually being shared. Thus, the SHWA protocol interface 120 passes the code into the fpars component 310, which serializes any critical sections should concurrent calls to shared hardware functions occur from sibling soft partitions (e.g., soft partition 140, FIG. 1) (509). This step (509) is also nested within steps 505 and 507. If a physical register access needs to occur as a consequence of a virtualized access, it is done in the GPE register 314 (511). Most actual GPE hardware accesses are expected to occur only inside the PMI interrupt handler of the PMI adapter 202, and all other interactions with GPE registers by OSs are virtualized by the SHWA protocol interface 120 and the firmware core 106.

FIG. 6 is a UML diagram that illustrates interrupt processing (method 130c) in a shared resource environment. In general, an interrupt handling sequence is implemented in which a CPU gets an interrupt from the hardware resource that it expects because it previously programmed it. When the interrupt arrives (e.g., because it is an interrupt that is caused by the shared interrupt controller), the OS instance 102 (e.g., SHWA proxy 122) interacts with the SHWA protocol interface 120 to complete processing. This interaction may involve clearing the interrupt and optionally reprogramming the controller to deliver the next interrupt to the same or a different CPU. Thus, in one embodiment, a kernel specific dispatch and ACPI OS-layer code is used to dispatch the IPI-based SCI into the ACPI GPE interrupt handler. The below described method can be defined by the ACPI architecture. At cold boot time, any shared IOSAPIC interrupts are programmed by the firmware 106 or 104 (e.g., PMI adapter 202 or the shared hardware module 120, respectively). In some embodiments, the programming may be implemented by the OS instance 102. The firmware 106 or 104 causes the IOSAPIC to send a PMI-type interrupt message to a healthy CPU within the hard partition. The firmware 106 or 104 may choose any CPU it deems suitable to perform PMI handling and may change the designated CPU during operation (e.g., during local MCA processing within one soft partition, the target CPU for the SCI interrupt may be moved to a CPU in a different soft partition). Such changes are implementation dependent and generally hidden from the OS instance 102.

Referring to FIG. 6, a PMI interrupt is delivered to the CPU 210 (601) and enters the PAL module 116 (603), which saves very minimal state and then branches to a previously registered entry point in the SAL module 114. This is architected behavior (e.g., the SAL and/or PAL interfaces specify the required firmware behavior). PMI interrupts are generally nonmaskable because disabling these interrupts also prevents the system from handling any other kinds of interrupts at all because it freezes interrupt state collection and so the CPU cannot resume normal execution after handling an interrupt. The PMI adapter 202 processes the interrupt and accesses the IOSAPIC hardware registers (605). Depending on the nature of the interrupt, one or more target CPUs (e.g., CPU 202) are interrupted using the previously programmed virtual redirection interrupts (607). Interprocessor interrupts may be used to signal the target CPUs, thus providing sufficient virtualization of the IOSAPIC hardware. In other words, the PMI adapter 202 substitutes an interrupt message that is normally sent from the IOSAPIC 312 to a single CPU in a single OS instance 102 to one in which the interrupt is sent to the firmware via a PMI level interruption. The PMI adapter 202 converts the interrupt into one or more CPU-to-CPU interrupt messages, depending on the nature of the interrupt source. There may be multiple interrupts from a hardware resource(s) which need to be sent to different CPUs in different soft partitions at the same time, but the IOSAPIC 312 can send an interrupt only to one CPU. Thus, fan in interrupt sources can be fanned out to possibly different recipients.

The CPU 210 receives an interrupt message (the virtualized IOSAPIC redirection interrupt) and branches into the OS vector corresponding to that interrupt (609). In other words, the CPU 210 recognizes an interrupt message, and based on the vector of that message (part of the interrupt message) and a vector table previously set-up by the OS instance 102, computes an offset into this table and reads the address of the instruction to begin executing the interrupt handler. The interrupt subsystem 302 recognizes this interrupt to be a shared/virtualized IOSAPIC interrupt and uses the SHWA protocol interfaces to clear and rearm the interrupt by calling one or more shared hardware functions that disable or change the CPU 210 or vector for this interrupt (611). Note this last function occurs if the SHWA protocol services had been discovered and initialized in the sequence described above.

A firmware core call is made that corresponds to every call occurring in 611. A function calf (613) is made from the SHWA proxy 122 to the SHWA protocol interface 120. Each virtualized IOSAPIC function called in 611 and 613 ends up here in this interaction with the PMI adapter 202 that implements the virtualized IOSAPIC state variables and interrupt behavior (615). The IOSAPIC registers are accessed in this call sequence only for exclusive use GSI interruptions. Shared interruptions may only update state variables in the PMI adapter 202 that support virtualization of these interruptions.

FIG. 7 is a UML diagram that illustrates GPE register access in a shared resource environment. The SHWA proxy 122 is initialized and queries the firmware configuration table 308 to look for the SHWA protocol interface GUID in a protocol list (701). If this service is not found, no shared hardware needs virtualized access. If it is found, the SHWA proxy 122 saves the protocol entry point to be used later by the ACPI subsystem 306 when accessing GPE registers 314 whose resource type is OEM-defined. The GPE registers 314 include those that are in the root (root GPEs, as described in the FADT), and those that are distributed (described in the ACPI namespace as GPE block devices). The SHWA proxy 122 and the ACPI subsystem 306 parse the table describing the root GPE (FADT) registers 314, and call the kernel interface primitive (i.e., primitive of the SHWA proxy 122) to query the SHWA proxy 122 to discover whether the root GPE registers are virtualized (703). Some of the functions corresponding to the SHWA protocol are discovery functions that are used by the OS instance 102 at boot time to determine which hardware functions are virtualized and which are not. Then, the OS instance 102 configures itself to use the SHWA functions that it needs to use. A SHWA protocol service is invoked (if present) to discover the access mode for these registers (705). If these root GPE registers are virtualized, their resource type can be set to 0xCO so that subsequent accesses by an interpreter (e.g., an interpreter or compiler of the ACPI subsystem 306) employ the virtualized OS layer interface instead of the direct/load store interface primitives. An interpreter knows how to process the ACPI tables of the ACPI module 118 and construct the ACPI namespace data structure. The data structure, as described above, may include virtual machine code that is executed by the interpreter during architected interactions (e.g., ejecting a PCI card, inserting a CPU or memory device, etc.) between the OS instance 102 and the platform hardware or the firmware. In 707, a byte read or write occurs inside the interpreter when the GPE register resource is 0xCO. The OS layer calls out to the SHWA proxy 122, which then invokes one or more primitives (709) to access a GPE register 314 described in the ACPI tables. Usually many accesses occur in a burst when the interpreter handles an SCI interrupt so that it may figure out the AML methods that must be invoked to service the interrupt.

Any process descriptions or blocks in the UML diagrams should be understood as representing modules, segments, or portions of code which include one or more executable instructions for implementing specific logical functions in the process, and alternate implementations are included within the scope of the disclosed systems and methods in which functions may be executed out of order from that shown or discussed, including substantially concurrently or in reverse order, depending on the functionality involved.

What is claimed:

1. A soft partitioning method, comprising:
instantiating a first operating system (O.S.) instance and a second O.S. instance in a first soft partition and a second soft partition, respectively; and
sharing hardware resources between the first O.S. instance and the second O.S. instance.

2. The method of claim 1, further including acquiring address descriptions of the hardware resources.

3. The method of claim 1, further including installing primitives to use a shared hardware protocol service.

4. The method of claim 1, further including determining which of the hardware resources are to be accessed using virtualized partition services.

5. The method of claim 1, further including programming virtualized hardware resources.

6. The method of claim 1, further including adapting hardware resource code of the first and the second O.S. instance to a shared hardware protocol.

7. A soft-partitioning system, comprising:
means for transferring hardware resource programming from a first operating system (O.S.) instance to a shared hardware protocol; and
means for providing sharing of the hardware resources between the first O.S. instance and a second O.S. instance.

8. The system of claim 7, wherein the means for transferring includes a shared hardware proxy.

9. The system of claim 8., wherein the shared hardware proxy provides an extended firmware interface (EFI) protocol.

10. The system of claim 7, wherein the means for providing includes a shared hardware protocol interface.

11. The system of claim 7, further including means for virtualizing the hardware resources.

12. The system of claim 7, wherein the means for virtualizing includes at least one of a shared hardware protocol interface, a shared hardware proxy, and core firmware.

13. A soft-partitioning system, comprising:
a first operating system (O.S.) instance and a second O.S. instance;
a hardware component;
a shared hardware proxy; and
a shared hardware protocol interface configured with the shared hardware proxy to enable sharing of the hardware component between the first O.S. instance and the second O.S. instance.

14. The system of claim 13, wherein the hardware component includes a processor.

15. The system of claim 13, wherein the hardware component includes a register.

16. The system of claim 13, wherein the hardware component includes an interrupt controller.

17. The system of claim 13, wherein the shared hardware proxy is located in at least one of the first O.S. instance and the second O.S. instance.

18. The system of claim 13, wherein the shared hardware protocol interface is located in at least one of the first O.S. instance and the second O.S. instance.

19. The system of claim 13, wherein the shared hardware protocol interface is located in firmware.

20. The system of claim 13, further including a firmware core, wherein the firmware core, the shared hardware protocol interface, and the shared hardware proxy are configured to virtualize the hardware component.

21. A soft-partitioning system on a computer-readable medium, the computer-readable medium comprising:
logic configured to adapt hardware resource programming in a first operating system (O.S.) instance to a shared hardware protocol; and
logic configured to provide sharing of the hardware resources between the first O.S. instance and a second O.S. instance.
